(19) United States
(12) Patent Application Publication
(10) Pub. No.: US 2012/0177288 A1
(43) Pub. Date: Jul. 12, 2012

(54) IMAGE-PROCESSING METHOD FOR CORRECTING A TARGET IMAGE WITH RESPECT TO A REFERENCE IMAGE, AND CORRESPONDING IMAGE-PROCESSING DEVICE

(75) Inventors: Benoit Chaussat, Aubiere (FR); Christophe Blanc, Pontgibaud (FR); Jean-Mare Robin, Vichy (FR)

(73) Assignee: VESALIS, Clermont-Ferrand (FR)

(21) Appl. No.: 13/388,511

(22) PCT Filed: Jul. 28, 2010
(86) PCT No.: PCT/IB2010/001914

§ 371 Date: Mar. 28, 2012

(30) Foreign Application Priority Data
Aug. 4, 2009 (FR) 09/03856
May 4, 2010 (FR) 10/01916

(51) Int. Cl. G06K 9/68

(52) U.S. Cl. 382/165; 382/218

(57) ABSTRACT

An automatic image-processing method for applying a mask onto a target image includes the following steps: a) obtaining a target image, in particular an image of a face; b) for at least one area of the target image, identifying the reference points corresponding to at least the points that make it possible to define a typical case of spatial imperfection; c) for at least that area, applying at least one test for detecting spatial imperfection by comparing the target image with a reference image; d) according to the spatial imperfection detected, identifying a spatial correction mask to be applied to the area of the image including said imperfection; and e) applying the mask onto the pertinent area of the target image. An image-processing system also is provided.

### FIELD OF THE INVENTION

The present invention relates to an image-processing method for generating a mask to correct or mitigate certain imperfections or irregularities detected on a target image.

The present invention also relates to a corresponding image processing system.

### BACKGROUND OF THE INVENTION

Several methods are known to simulate the generation of masks, for example in the field of makeup. A user provides an image of her face on which makeup is to be applied, and in return, obtains a modified image on which a color mask appears. This mask is used by the user who may employ it as a template so that she can obtain a makeup. Since it is applied to an image of the user's face, and not to an image of a template with different features, the mask produces a realistic effect, which constitutes an excellent template for makeup to be applied by the user herself or a makeup artist. In practice, the known facilities offering such services resort to specialist staff who manually prepare a mask, or touch up the provided image, thus simulating a type of automatic process. Such an approach implies complex logistics, large set-up times and high costs. Moreover, since these are manual techniques, the results provided are not constant over time for a given image, which will unavoidably be treated differently if several different specialists intervene independently.

### SUMMARY OF THE INVENTION

To avoid having to resort to human intervention in the process of designing a mask, and in particular to ensure the production of a very large number of images while ensuring good repeatability, very short response times and stability of the results, the present invention provides various technical means.

A first object of the present invention is to first provide an image-processing method for defining a mask to be automatically applied to a target image, in particular to well-defined areas of the image, such as the mouth, eyes, cheeks, etc.

Another object of the present invention is to provide a method for generating a mask intended to contribute towards the correction of imperfect areas, especially for an image representing a face.

These objects are achieved by means of the method defined in the appended claims.

The present invention thus provides a method for automatic image-processing intended for the application of a mask to be applied to a target image, including the steps of:

a) obtaining a digital target image, in particular an image representing a face;
b) for at least one area of the target image, automatically identifying the reference points which correspond at least to the points which make it possible to define a typical case of spatial imperfection (the areas in the mask to be applied);
c) for at least this area, applying at least one spatial imperfection detection test by comparing the target image with a reference image;
d) depending on the detected spatial imperfection, automatically identifying/selecting a spatial correction (or compensation) mask to be applied to the area of the image which includes said imperfection;
e) applying said mask to the relevant area in the target image.

Once the different features of a face are known it is possible to correct and hide its defects. The art of makeup is to get as close as possible to an ideal face, for example the aesthetic canon. The present invention allows an image to be compared to a reference image, in order to reveal discrepancies between a target image and a reference image to the user.

According to one advantageous embodiment, the method further comprises, before the step of applying the correction mask, the steps of:

identifying at least one color feature (hue, contrast, brightness) of said area of the target image;

according to at least one of these characteristics, generating color correction features (correction filter);

assigning or adding these correction features to the spatial correction mask in order to obtain an overall correction/compensation mask;

applying the overall correction mask to the relevant area of the target image.

Advantageously, the comparison between the target image and the reference image involves a comparison between the relative arrangement of one or more key points of the relevant area of the target image and the corresponding points of the reference image. These point-by-point comparisons are not computationally intensive and provide very good results because the compared items are reliable and constant from one image to the next. The process can be developed at a very large industrial scale with excellent reliability,

According to an advantageous embodiment, the target image represents a face as seen substantially from the front, and the relevant areas are selected from the group consisting of the mouth, eyes, eyebrows, face outline, nose, cheeks, and chin. The components of the face relief in the image represent a face in which a plurality of spatial reference points are recorded.

According to one exemplary embodiment, the area of the target image comprises the mouth and the reference points comprise at least the corners of the mouth. It also preferably comprises a substantially central point of the lower lip which is furthest from the center of the nose and preferably also one of the two highest points of the upper lip, and finally, the lowest point between the two above-mentioned points and the two points of the upper lip.

According to another exemplary embodiment, the area of the target image comprises the eyes.

According to yet another exemplary embodiment, the area of the target image comprises the eyebrows.

According to yet another exemplary embodiment, the reference points comprise a plurality of points located substantially along the outline of the face.

In an advantageous embodiment, the reference image substantially corresponds to the face of the aesthetic canon, whose physical proportions are established in a standard manner.

The present invention further comprises an image-processing system to implement the above-described method.

The present invention finally comprises an image-processing system which comprises:

a comparison module adapted to perform a comparison between certain features of at least one area of a target image and similar features of a reference image based on test criteria applied in order to detect any imperfections in the area of interest with respect to the shape features of the target image;

a selection module adapted to select at least one correction mask to be applied to the area of interest of the target image, said mask being selected according to the type of imperfection detected by the comparison module;

an application module, for application of the selected mask to the target image in order to obtain a modified image.

According to one advantageous embodiment, the comparison, selection and application modules are integrated into a work module implemented by means of coded instructions, said work module being adapted to obtain target image data, reference image data and test criteria.

### DESCRIPTION OF THE FIGURES

All implementation details are given in the following description with reference to FIGS. 1 to 26, which are presented by way of non-limiting examples, in which identical reference numbers refer to similar items, and in which:

FIG. 1 shows an example of a target image obtained for processing purposes according to the method of the present invention with the face outline detected and identified;

FIG. 2 corresponds to the original target image, before it is processed;

FIGS. 3 and 4 illustrate an exemplary reference image, which, in the present case, is the Aesthetic canon, with the main points allowing the comparisons with a target image to be performed;

FIGS. 5 and 6 illustrate an exemplary target image with the points corresponding to those shown in FIGS. 3 and 4 for the reference image;

FIG. 7 shows the points and sizes allowing the eye orientation to be detected in a target image when compared to the reference image;

FIG. 8 shows the points used in detecting the type of spacing between the eyes when compared to the reference image;

FIG. 9 shows the points and distances used in detecting the shape of the eyes in the target image when compared to the reference image;

FIG. 10 shows the points and distances used in detecting the proportion of the mouth of the target image when compared to the reference image;

FIG. 11 illustrates the points and distances used in detecting the size of the lips in the target image when compared to the reference image;

FIGS. 12 and 13 are block diagrams illustrating the main steps of the image processing method according to the present invention;

FIGS. 14a, 14b and 14c show a HSB diagram used in determining the available colors closest to the colors detected in the target image;

FIG. 15 schematically shows the main modules and elements provided for the implementation of the method according to the present invention;

FIGS. 16a to 16d show the lips of a target image with different retouching examples designed to correct various types of defects detected on the lips after comparison with a reference image;

FIGS. 17a to 17c show different mask examples for the eyes according to the type of eye detected;

FIGS. 18a to 18c show correction examples as a function of the type of face detected for the target image when compared to the reference image;

FIGS. 19 and 20 show certain key points and distances for detecting the shape of a face in the target image;

FIG. 21 illustrates the points and distances useful in detecting the type of chin with respect to that of the reference image;

FIG. 22a illustrates the points and sizes useful in detecting the type of nose in the target image in relation to the reference image;

FIGS. 22b, 22c and 22e show examples of corrections to be applied to the nose according to the detected characteristics;

FIG. 22d illustrates the points and sizes useful in the detection of the shape of the nose in the target image in relation to the reference image;

FIG. 22f illustrates the points and sizes useful in detecting the width of the nose in the target image in relation to the reference image;

FIG. 23 shows the points and distances for determining, according to another approach, the shape of the face in the target image in relation to the reference image;

FIGS. 24 and 25 show the points and sizes useful in establishing the criteria used in the detection of the size of the eyes;

FIG. 26 shows the points useful in determining the distance between the eye and the eyebrow in a target image.

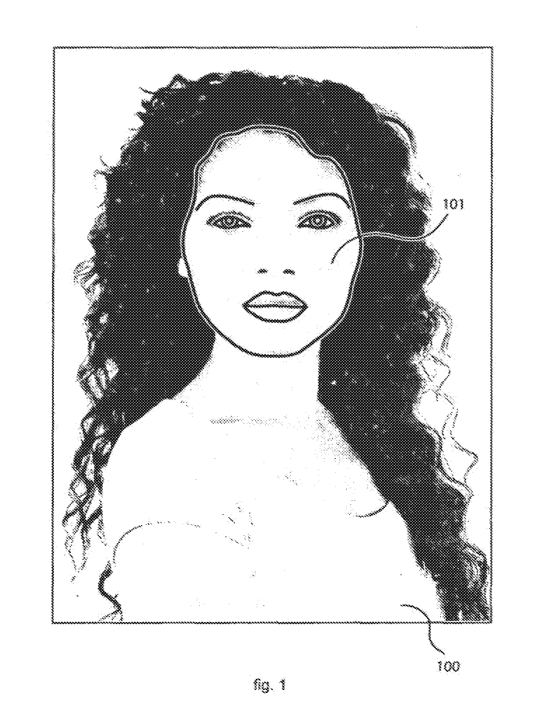

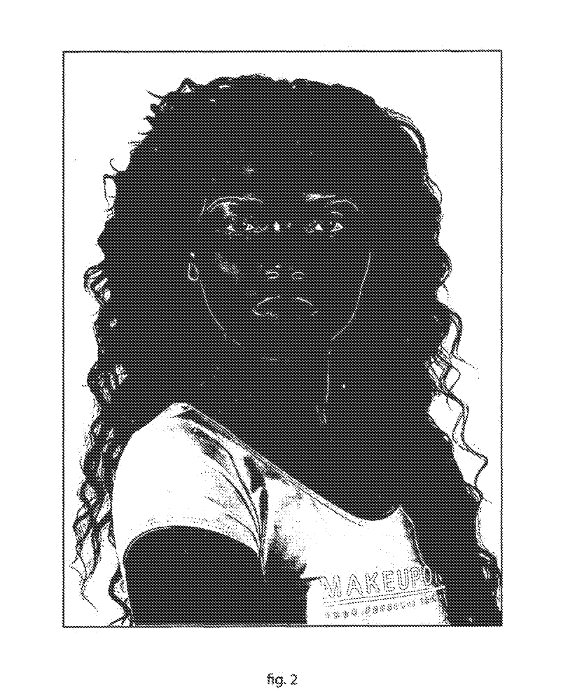

### DETAILED DESCRIPTION OF THE INVENTION

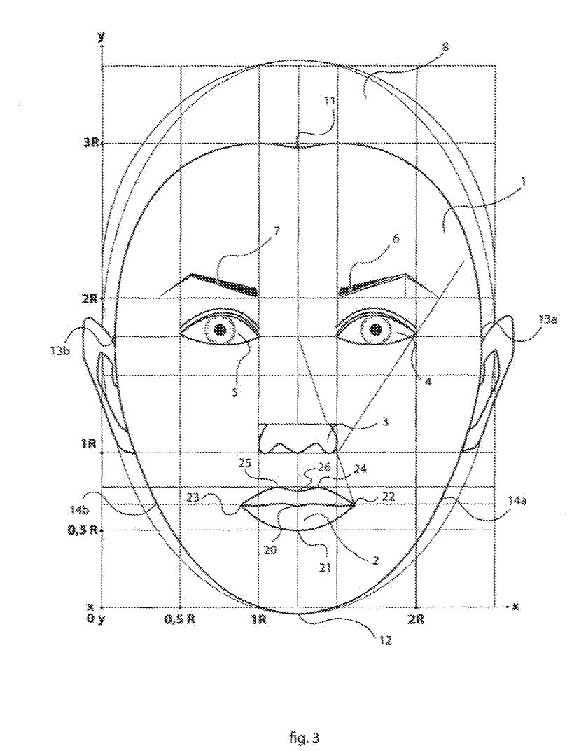

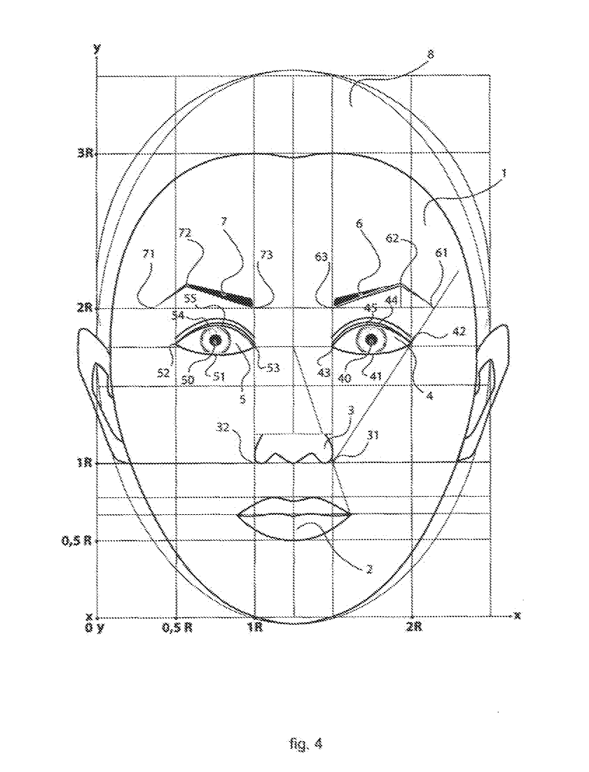

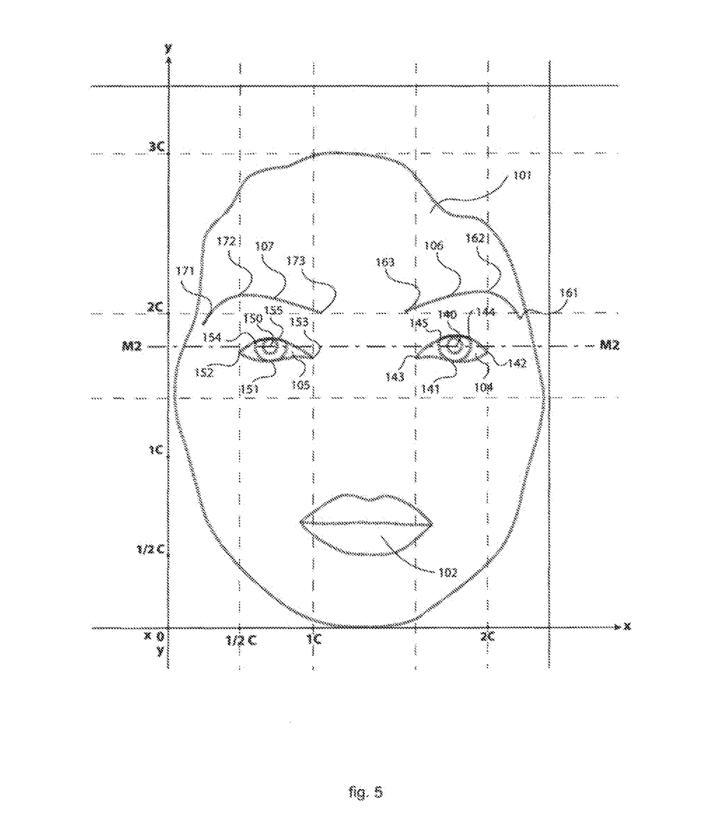

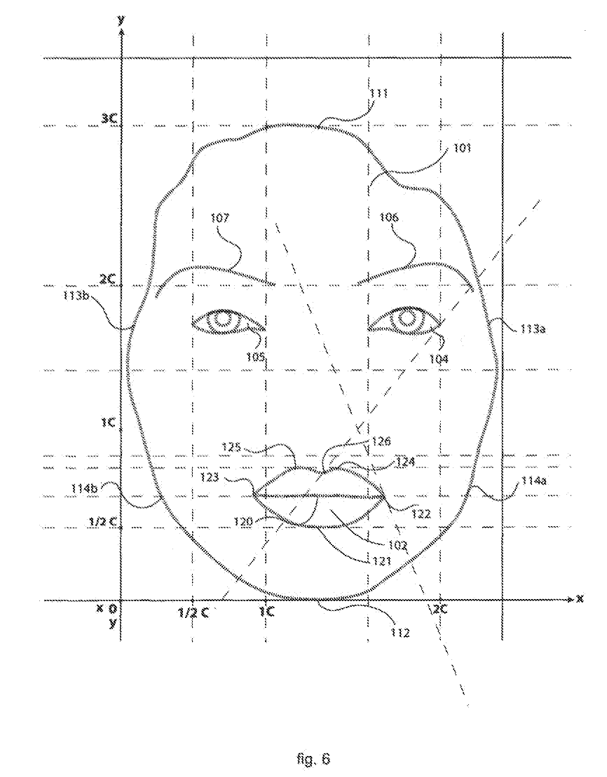

The reference for the proportions of a face is the ideal face 1, known as the Aesthetic canon, used as a template in classical painting. The Canon is considered to be the ideal face. It has perfectly balanced proportions. FIGS. 3 and 4 illustrate the Canon generally recognized as the ideal reference.

According to this Canon, the oval shape is considered to be ideal. The distances between the eyes 4 and 5, from the nose 3 to the mouth 2, as well as the distance between the eyes and the bottom of the chin, and also the ratios between these distances, must correspond to certain standard values. The oval face has the following sizes, expressed in absolute units, as shown in FIGS. 3 and 4.

The height of the head is 3.5 units. The beginning of the scalp 11 and the top of the head cover 0.5 units. The width of the head is 2.5 units. The width of the face is 13/15 of the head.

The ears are located in the second height unit. The nose 3 is on the midline of the face and in the second height unit. Its width corresponds to half the center unit. The height of the nostrils is 0.25 units.

For the eye, the inner corners of the eyes 43 and 53 are located on either side of the center half-unit. Along the vertical or longitudinal axis, the inner corners of the eyes are at 1.75 units from the reference O. The width of the eyes 4 and 5 covers 0.5 units.

The inner corners of the eyebrows 53 and 73 are on the same vertical line as the inner corner of the eye, on the same side. The outer corners of eyebrows 61 and 71 are located on the same line passing through the outer corner of the eye 42 or 52 and the outer corner of the nostril 31 or 32, on the same side. The height of the eyebrow 6 or 7 is a third of its length, extending outward, and its top 62 or 72 has a height of a quarter of its length.

The mouth 2 rests upon the horizontal line located halfway up one unit and covers a half-unit in height. The height of the mouth 2 is expressed as a function of the respective heights of the lower and upper lips: the lower lip covers a third of a ½ unit. The upper lip covers a third of the remainder of a ½ unit.

The width of the mouth 2 is defined on the basis of the two lateral end points 22 and 23 of the mouth. These two lateral end points of the mouth are each located on a straight line passing through both the half-way point between the eyes, and the lower outer points of the nostrils 31 and 32. The mouth is also bounded by the lower point 21 and the upper points 24, 25 and 26.

### Main Steps of the Method

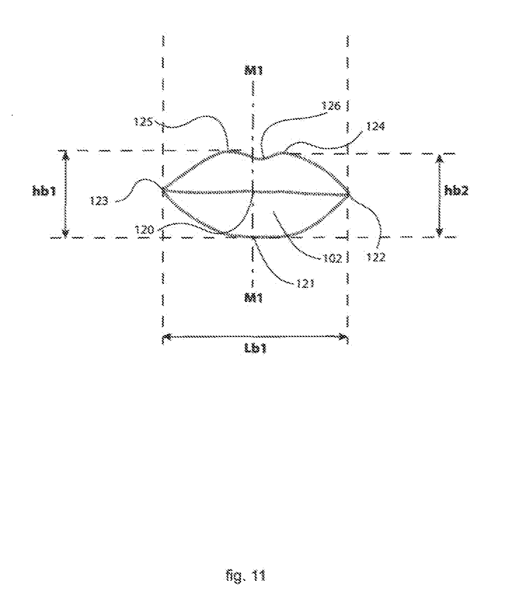

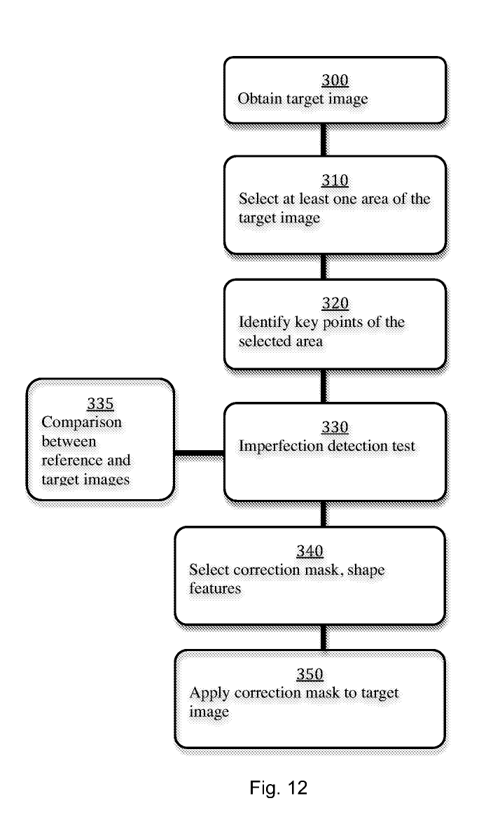

FIG. 12 shows the key steps of the method for correcting a target image with respect to a reference image in the form of a flow diagram. In step 300, a target image is obtained. In step 310 at least one area of this image is selected for processing. The key points of at least this area are identified in step 320. The preferred identification modes for these points are described in detail in document WO 2008/050062. Other detection methods may also be used. In step 330, the test criteria are applied in order to detect any imperfections in the area of interest. The tests applied involve a comparison 335 between the features of the target image with respect to similar features of the reference image. Depending to the imperfections detected as regards to the shape features of the target image, one or several correction masks are identified in step 340. In step 350, the chosen masks are applied to the target image in order to obtain a modified or corrected image.

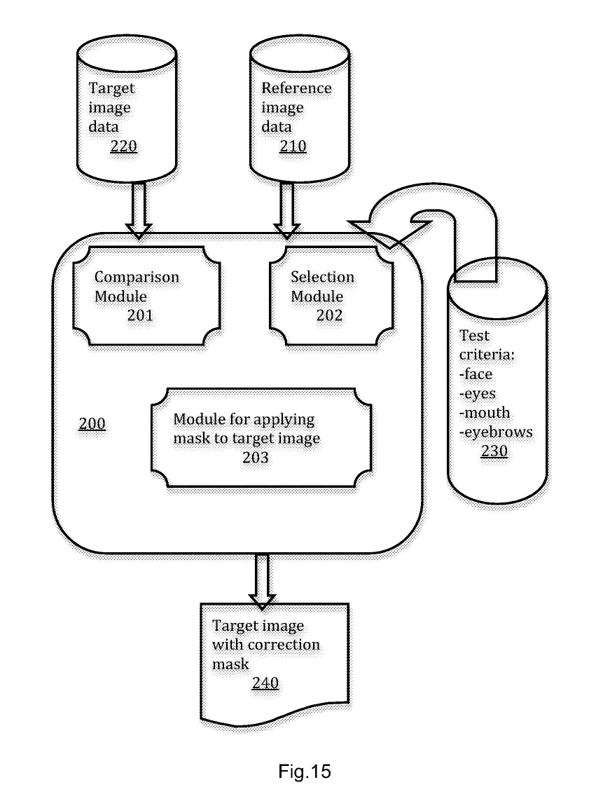

FIG. 15 shows the interrelationship between the key steps of the process and the different functional modules invoked at different times during the process to enable its implementation. Thus, data 210 from the reference image and data 220 from the target image are made available, for example based on their memory locations. When the process is implemented by conventional computer means which comprise one or more microprocessors, memory means and implementation instructions, a work module 200 includes a comparison module 201, a selection module 202 and a module 203 intended to apply the selected mask to the target image. The test criteria 230 are made available, for example, by the memory means. At the end of the process, the modified image 240, that is, the target image onto which the correction mask has been applied, is obtained.

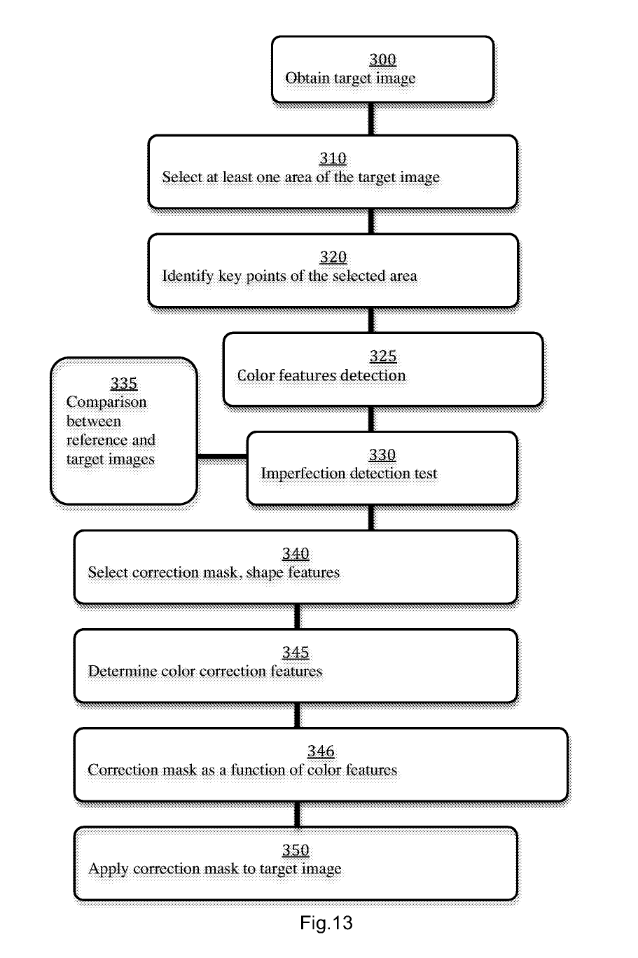

FIG. 13 shows an alternative embodiment in which one or more tests are performed in relation to the color of the reference image. Thus, in step 325, the color features of a defined area are detected with respect to the target image. These may be skin color features for one or several areas of the face, or eye and/or hair color features. In step 345, any corrections needing to be applied to the target image based on the color features detected in step 325 are defined. In step 346, the correction mask defined in step 340 is modified to reflect color corrections before application to the target image in step 350.

The following description provides examples of comparisons performed between a target image and a reference image to detect features of the face represented by the target image. The detection of facial shape, orientation, eye spacing and size, eye and mouth shape, lip size, relative proportions therebetween, the size of the chin or nose, and the distance between eyebrows and eyes, are shown in turn. Finally, the selection of colors is described.

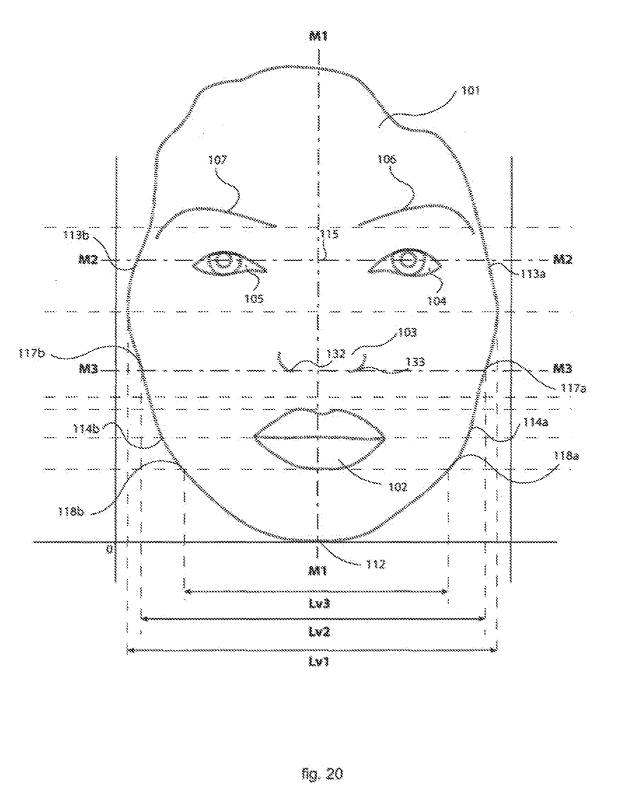

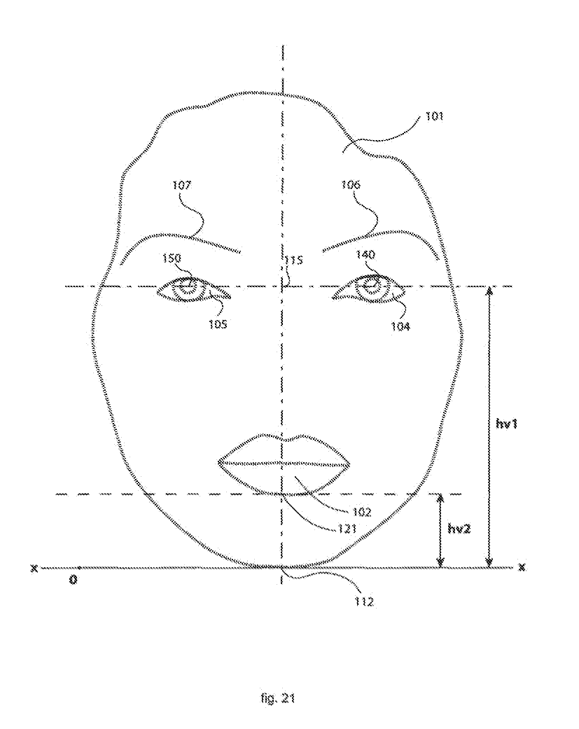

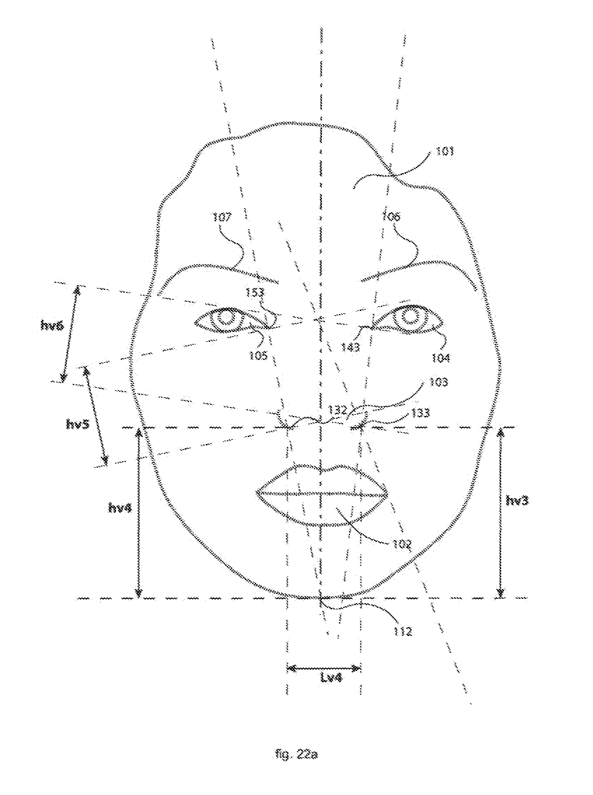

### Facial Features: The Shapes of the Face (FIGS. 20 and 21)

The shape of the face is one of the fundamental facial features. However, it is technically very difficult to accurately detect the exact outline of a face. The junction area with the scalp also poses significant detection problems, especially when the transition is gradual. The demarcation of the lateral edges and the chin, often with shaded areas, also involves many difficulties and chronic inaccuracies.

Nevertheless, to compare the image of a face with a reference image, it is desirable to compare, on one hand, the different facial elements, such as the mouth, eyes, nose, etc., but also the general shape of the face.

In this description, various technical tools and criteria are presented and illustrated in order to detect the shape and/or category to which the outline of the face or part of it belongs. These detections are performed in relation to the outline or corresponding elements of the reference image. In one advantageous embodiment, the reference image corresponds to the aesthetic canon.

In order to detect the typical shape or category of a face, distance ratios are used. The target face 101 can be sorted or classified according to typical shape categories, preferably as follows: round, oval, elongated, square, undetermined. Other classes or subclasses can also be used, such as heart or pear shapes, inverted triangles, etc. Different criteria make it possible to determine the class to which a given face belongs. The dimensions used to perform these tests are illustrated in FIGS. 20 and 21.

In the following criteria, the following distances are used: Lv1 is the area on the target face with the greatest width 101, and Lv3 is the width at the lowest point 121 of the lips 102. The width Lv2 is measured at the nose level using the points 132 and 133 defining the nostrils. Hv1 is the height between the bottom point of the chin 112 and point 115 located at the height of the pupils 140 and 150 of the eyes 104 and 105.

A face is:

round if: Lv1/hv1>1.3 and if Lv1/Lv3<1.4.

elongated if: Lv1/hv1<1.2.

triangular if: Lv1/Lv3>1.4.

square if: Lv1/hv1<1.3 and if Lv1/Lv3<1.45 and if Lv2/Lv3<1.25.

oval if: Lv1/hv1<1.3 and if Lv1/Lv3<1.45 and if Lv2/Lv3>1.25.

FIGS. 18a, 18b and 18c show examples of correction or compensation masks. After a comparison has been performed between the target image and the reference image, the shape of the face in the target image is detected, preferably with the above criteria. According to the type of face detected in the target image, one or more correction masks are proposed so that the target image may have a shape close to that of the reference image. For example, in FIG. 18a, a square face is corrected or compensated for using a mask intended to remove or reduce the visibility of the lower portions or “corners” of the cheeks or jaws f7ad and f7ag. For reduced visibility, the colors, hues and/or textures are selected so as to minimize light reflection from the areas to be masked.

FIGS. 18b and 18c illustrate mask types intended to correct a face whose detected shape is either too round (FIG. 18b) or too elongated (FIG. 18c). In the first case, to correct a round face, in areas f7bd and f7hg, a darker application of the detected skin hue is considered in order to darken this portion of the face, and thus make it less visible. Additionally, in area f9b at the base of the chin and area f8b on the forehead, a highlight area is provided using an application that promotes light reflection, thus making this area more visible.

In FIG. 18c, the reverse approach is followed. To correct the elongated face, areas f7cd and f7cg are brightened in order to increase light reflection and to make that portion of the face more prominent. The base of the chin in area f9c is darkened in order to make it less conspicuous. Area f8c, at the forehead, can also be attenuated if necessary.

FIG. 23 illustrates another approach according to which the shapes of a face can be found. A circle whose center is a central point on the face is used to establish a spatial basis for comparison. Firstly, an OVCA outline (the Canon Face Oval, or outline of the reference image) is overlaid on top of the target image. This overlay is performed by placing point 15, which is located at half the distance between the pupils of the OVCA outline and the reference image, at point 115 of the target image, and the lowest point 12 of the face, at the corresponding point 112. Point 15/115 is used as the center of the circle. The radius is chosen based on the distance between point 15 and point 12. Once both images have been overlaid, the reference image is resized as a function of the size of the target image. It is then possible to compare the OVCA shape with the target image outline. The comparison is preferably performed on a point-by-point basis, starting from predefined key points. The circle is advantageously used as a new reference to measure the distances between the latter and various points along the outline and the target image. For example, distance Lvc7 can be used to evaluate the distance from point 119c at the top of the forehead to point 119c2 on the circle. On the other side of the face, distance Lvc8 has a similar value. At the bottom of the face, the distances between point 119a of the outline and point 119a2 on the circle, on the one hand, and between point 119b of the outline and point 119b2 on the circle, on the other hand, can be evaluated based on distances Lvc3 and Lvc5. All distances are measured using straight lines passing through the points to be evaluated and the center 115 of the circle. This approach can also be used to compare other facial components between both images. Alternatively, this approach is used to compare the positions of points of the outline in the target image with respect to a reference outline (OVCA) without having to use the intermediate reference circle. In addition to the spacing between points, it is then useful to provide an indication specifying whether the point in the target image is inside or outside the reference outline.

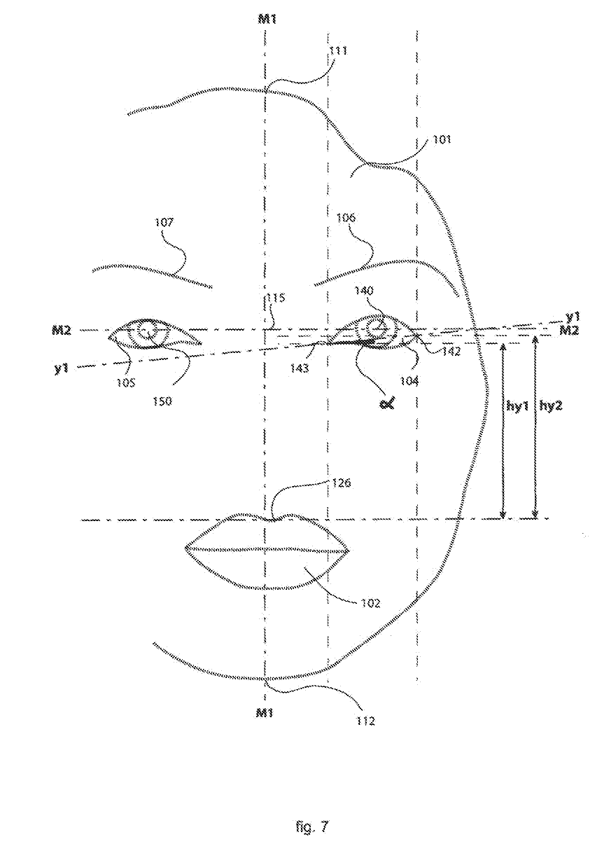

### The Eyes: Eye Orientation (FIG. 7)

In addition to detecting the shape of the face to apply an appropriate correction mask, it is useful to detect certain characteristics related to features of the target face such as the shape and/or orientation or size of the eyes, the shape of the mouth and size and/or proportion of the lips, the type of chin or nose, etc. Thus, it becomes possible to provide correction masks that are defined for each area, according to the type of detected features.

FIG. 7 shows the points and sizes that are useful in establishing the criteria relating to the detection and inclination of the eyes in the target image with respect to the reference image. Depending on the inclination, the eyes are advantageously classified or sorted into three categories: drooping, normal (right) or slanted.

There are several criteria to establish this classification. According to a first approach, the slope (angle alpha in FIG. 7) of a straight line y1-y1 passing through the inner corner 143 and the outer corner 142 of the eye is used. This slope is given by a value in degrees. According to this approach, the eye is determined to be:

Normal: if the angle alpha is greater than 358 degrees and smaller than 5 degrees (or within the range of +/−7 degrees about the horizontal axis).

Slanted: if the angle alpha is greater than 5 degrees and smaller than 30 degrees.

Drooping: if the angle alpha is greater than 328 degrees and smaller than 358 degrees.

Other values can be assigned to this type of test based on the desired results.

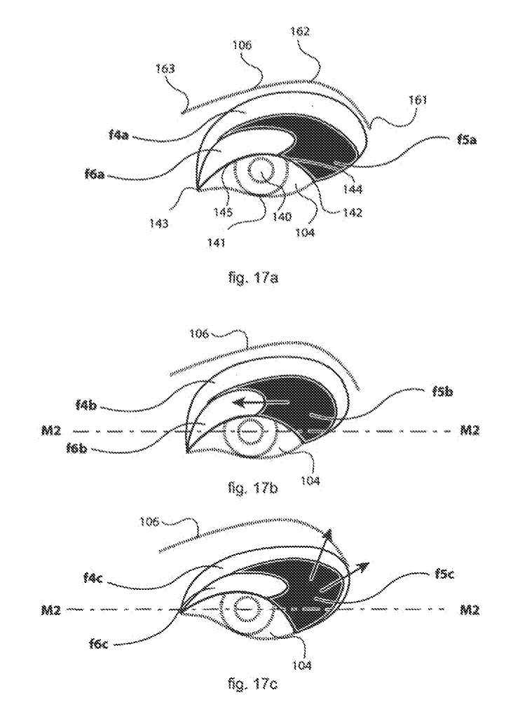

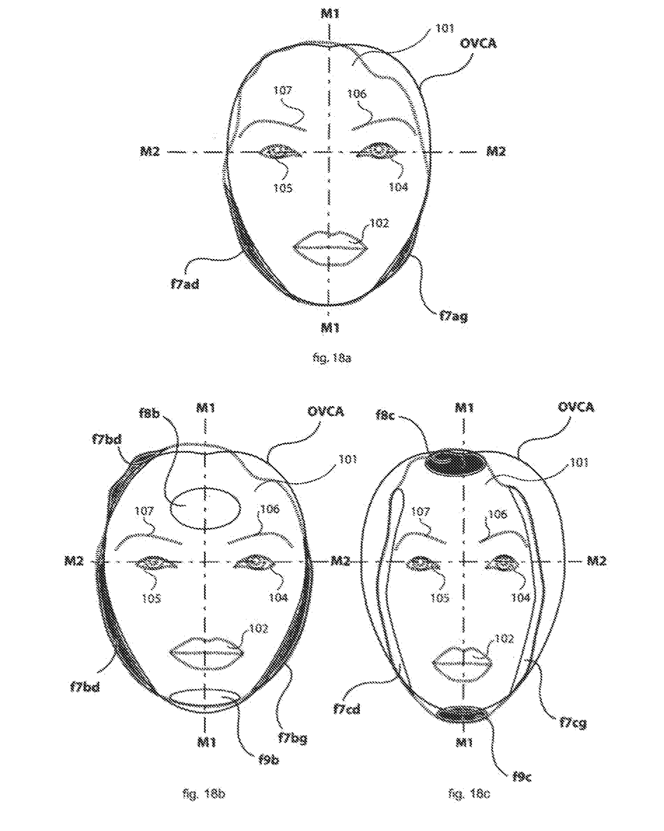

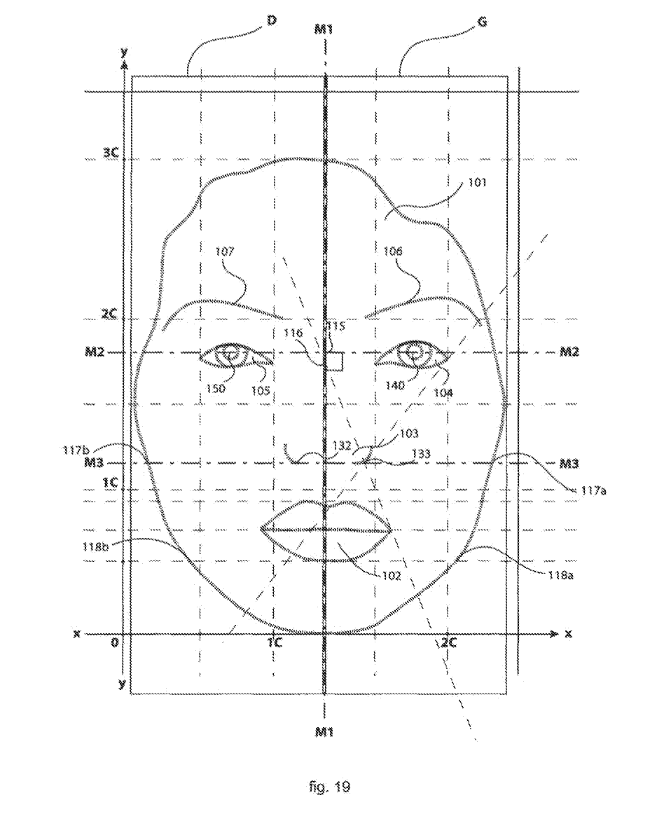

For eyes belonging to the normal category or corresponding to those of the reference image, the mask is not intended to provide any particular compensation or correction. FIG. 17a shows a typical mask intended to decorate an eye that shows no particular imperfection. This mask has a neutral impact on the shape, but produces a coloring effect intended to embellish the eyes of the person wearing such makeup.

In the second case, the mask to be applied will be intended to provide a correction that does not further enhance or only slightly increases the eye slanting effect, since this effect is often sought after.

Finally, in the third case, the mask to be applied will be intended to provide a correction which attenuates the drooping effect. FIG. 17c shows an exemplary mask, which provides such an effect. A dark area f5c, which becomes more enlarged towards the upper outer corner of the eye, produces such an effect.

According to a second advantageous approach, reference is made to the difference in height expressed by hy2 and hy1 in FIG. 7. Both of these heights express the difference in height between the inner corners 143 and 142 of the eye. The following criteria are thus established. The eye is:

normal if hy1 is substantially equal to hy2.

drooping if hy1 is substantially greater than hy2.

slanted if hy1 is substantially smaller than hy2.

The masks aim to provide the same corrective or compensating effects as those listed above with respect to the first approach.

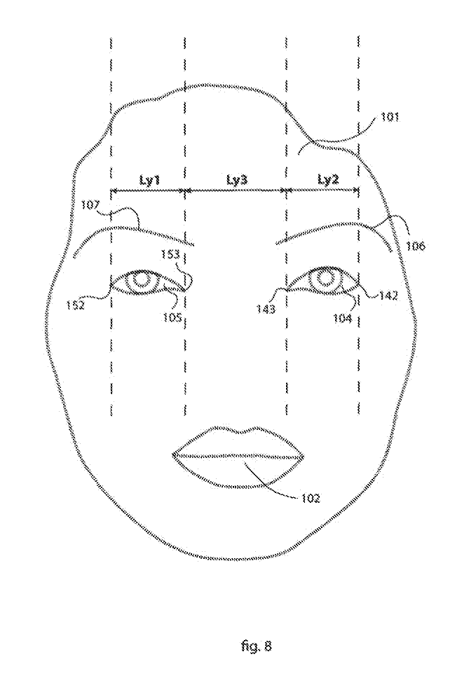

### Eye Spacing (FIG. 8)

FIG. 8 shows the points and sizes useful in establishing criteria used in the detection of spacing between the two eyes of the target image with respect to the reference image. This spacing can be classified into three categories in which the eyes are considered to be close to each other, normally spaced or far apart. The points used for these criteria correspond to the inner ends 143 and 153 and outer ends 142 and 152 of the eyes 104 and 105.

The eyes are normally spaced or spaced equivalently to the reference image if:
(Ly1+Ly2)/2 is substantially equal to Ly3.
The eyes are close to each other if: (Ly1+Ly2)/2 is substantially smaller than Ly3.
The eyes are far apart if: (Ly1+Ly2)/2 is substantially greater than Ly3.

For eyes spaced similarly to the reference image, that is with a standard spacing, the mask to be applied will not be intended to provide any compensation or correction.

In the second case, the mask to be applied will be intended to compensate for the small spacing by means of an illuminating effect which increases the spacing.

In the third case, the mask to be applied is intended to compensate for the large spacing by means of a shading effect, which produces a distance-reduction effect. An example of this type of mask is shown in FIG. 17b. Such a mask will create a distance reduction between the eyes by means of a dark area above the eye covering at least its outer side, whereas for a normal eye, as shown in FIG. 17a, the dark area of the mask above the eye barely reaches the upper outer corner of the eye. The widening of the dark area f5b shown in FIG. 17b creates an eye spacing reduction effect.

### Size of the Eyes (FIG. 25)

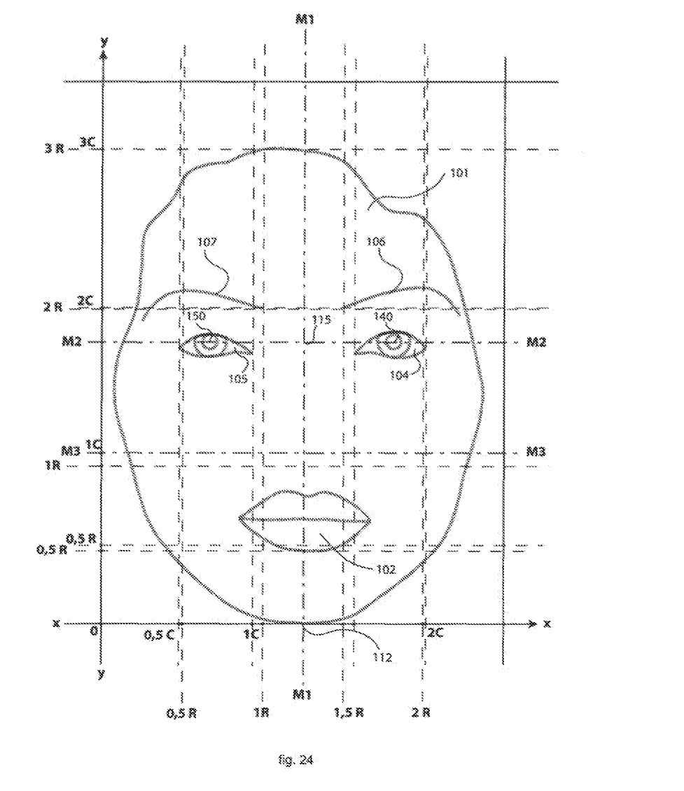

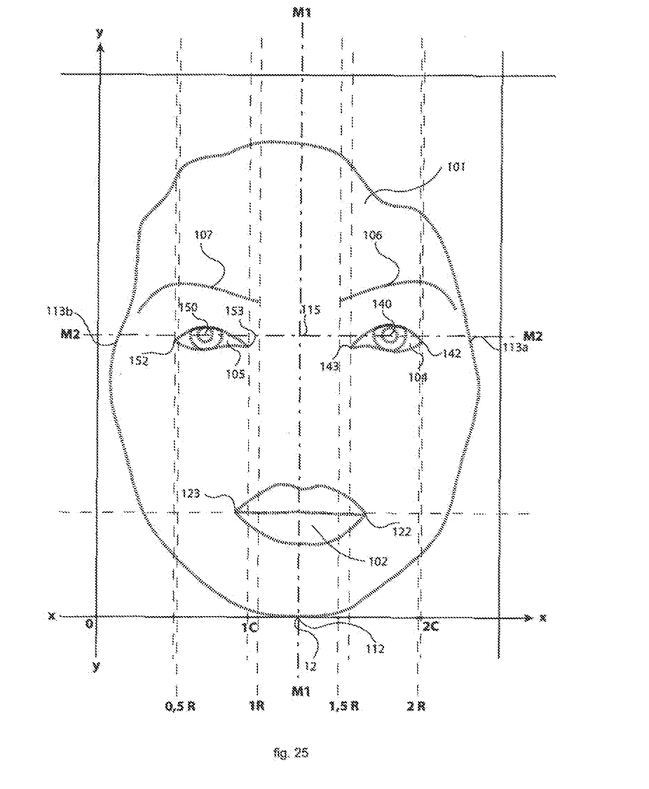

FIGS. 24 and 25 show the points and sizes that are useful in establishing the criteria relevant to detecting the size of the eyes. These criteria are intended to establish the eyes' proportions with respect to the rest of the face and its components. The eyes are advantageously classified into three categories: small, normal (well proportioned), or large. Thus, the proportion of both eyes with respect to the rest of the face and its components can be known.

A first approach is to overlay the reference image onto the target image. This superposition makes it possible to implement a scale adjustment of the reference image. Points 13a and 13b of the reference image (see FIG. 3) are preferably used to manage the change in width scale. The reference grid is centered by overlaying its point 15, which is located in the middle of the distance between the centers of the pupils, onto the corresponding point 115 of the target image. The outline points 113a and 113b of the face located at the same height as point 115 are then used to adapt the width scale. The point is advantageously chosen on the basis of the greatest distance from point 115 to either point 113a or point 113b. The point farthest from the center is retained. The reference scale R is adapted (increased or decreased, as appropriate), so that the corresponding points 13a or 13b of the reference image are aligned in width depending on the distance retained.

The reference scale is adjusted in height by overlaying the point 12 onto the point 112 of the target image. After these adjustments, FIG. 25 shows that scale R of the reference image does not match scale C of the target image. The deviations between the two scales may thus serve to detect the differences in position between the points of the target image which must be evaluated or compared. It then becomes possible to compare all of the differences between sizes, distances, etc., of the facial components of the target image and reference image. In these Figures, the units of the reference grid are denoted R.

According to this approach, to detect the type of eye, the distances between the two corners of the eyes 152 and 153 or 142 and 143 are compared using both scales, which correspond, for eye 105 to 0.5C or 0.5R and 1C and 1R. Thus, the two eyes are:

Normal if: the length from 0.5C to 1C is substantially equal to the length from 1.5R to 1R. In this case, the mask to be applied will not be intended to provide any compensation or correction.

Small if: the length from 0.50 to 10 is substantially greater than the length from 1.5R to 1R. The mask to be applied will be intended to enlarge the eye, for example by graduating the color or by using a lighter color. The mask preferably uses a ratio greater than that used for a normal application (case of the aesthetic canon).

Large if: the length from 0.5C to 1C is substantially smaller than the length from 0.5R to 1R. The mask to be applied will be intended to shrink the eye, for example by reducing the size of the area where color is applied. The mask preferably uses a ratio smaller than that used for a normal application (case of the aesthetic canon).

The size of the eyes can also be detected by computing the surface area of the eyes as a function of the surface area of the face. This latter surface area is easily known based on points that are known and/or detected along the outline. According to this approach, the eyes are:

Normal if: the percentage covered by the surface area of the eyes with respect to the surface area of the face is substantially the same on the target image and the reference image.

Small if: the percentage covered by the surface area of the eyes with respect to the surface area of the face is substantially smaller on the target image than on the reference image.

Large if: the percentage covered by the surface area of the eyes with respect to the surface area of the face is substantially greater on the target image than on the reference image.

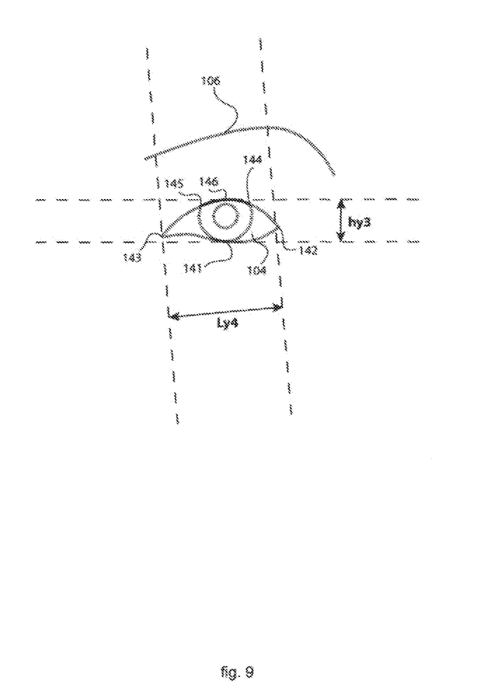

### Shapes of the Eyes (FIG. 9)

FIG. 9 shows the points and sizes useful in establishing the criteria for detecting the shape of the eyes. These criteria are intended to establish the proportions of the eyes with respect to the rest of the face and its components.

The eye shape criteria correspond to the shape of the opening of the eye. Classification into three categories is performed: narrow, normal (well proportioned), or round. Other categories may be defined in order to refine the accuracy or to take specific cases into account. The eyes of the canon are well proportioned, with a height corresponding to a third of their width. In order to check the possible corrections to be applied to the eyes of the target images used for comparison, the following criteria are applied. The points used for these criteria correspond to the ends 142 and 143 of the eyes for segment Ly4, whereas segment hy3 is defined by the lowest point 141 and the highest point 146 of the eye. Thus, an eye is:

normal if hy3 substantially corresponds to ⅓ Ly4, corresponding to the canon.

narrow if hy3 is substantially smaller than ⅓ Ly4.

round if hy3 is substantially greater than ⅓ Ly4.

Depending on the type of eye detected, different types of correction masks can be suggested for correcting shapes that deviate from those of the canon. The masks are such as to refine the profile of a round eye or such that an excessively narrow eye is made rounder. The corrections identified in accordance with the various criteria may be of various kinds. Certain corrective masks are masks of the outline type with varying thickness, shapes and colors. Such masks define areas with tarnished colors, with different shapes and varying brightness. It is also possible to partially or entirely distort or enhance the lashes, located on the outline of the eye.

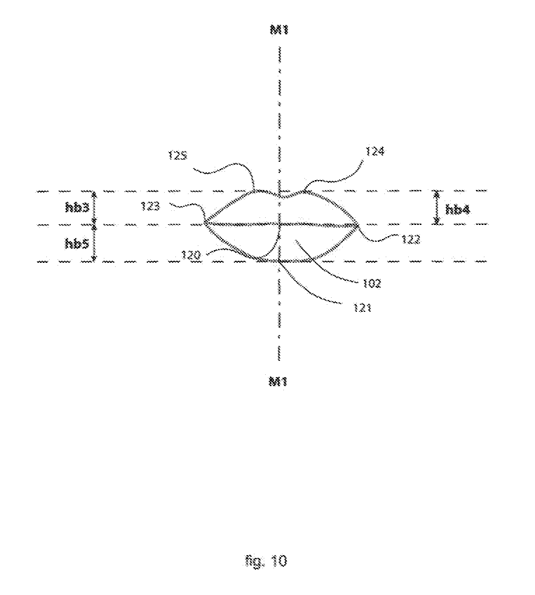

### Size/Shape of the Mouth (FIG. 10)

FIG. 10 shows the points and sizes useful in establishing criteria for detecting the shape of the mouth. These criteria are intended to establish the proportions of the mouth in the target image with respect to the rest of the face and its components, in relation to the reference image. The points used for these criteria correspond to the upper and lower points of each lip, that is, for hb3, to the distance between the imaginary line passing through the corners 122 and 123 and the upper point 125 of one side, for hb4, to the distance between the imaginary line passing through the corners 122 and 123 and the upper point 124 of the other side, and for hb5, to the distance between the lower point of the lower lip 121 and the line passing through the corners of the mouth, at points 122 and 123.

The mouth can be classified into three categories: narrow, normal (well proportioned), or wide. If the comparison is performed with respect to the canon, for the latter, the proportions of the mouth are given by the following relation:

Lb1=¾ unit, where Lb1 is measured between points 122 and 123 as shown in FIG. 11. The mouth is normal or similar to that of the reference image if:
Lb1 substantially corresponds to ¾ of unit R (reference image).
The application is similar to that performed with the reference image.
The mouth is narrow if: Lb1 is substantially smaller than ¾ of unit R.
The application seeks to widen the mouth by drawing the outline of the lips with a slight extension towards the corners of the mouth.
The mouth is wide if: Lb1 is substantially greater than ¾ of unit R.
The application seeks to reduce the width of the mouth by drawing the outline without the corners of the mouth, and possibly, by attenuating the corners of the mouth.

### Size of the Lips (FIG. 11)

FIG. 11 shows the points and sizes useful in establishing the criteria for detecting the size of the lips with respect to the reference image. These criteria are intended to establish the proportions of the lips with respect to the mouth. This consists in detecting the size of the lips by determining the ratio of the width to the height of the mouth or the height of the lips. The lips may be classified into three categories: thin, normal (well proportioned), thick. The points used for these criteria correspond to the upper and lower points of each side of the mouth in the target image, that is, for hb1, to the distance between points 125 and 121, and for hb2, to the distance between points 124 and 121.

The lips are normal if: (hb1+hb2)/2 is substantially equal to Lb1/2.7, in other words the proportions corresponding to the lips of the reference image.
The lips are thin if: (hb1+hb2)/2 is substantially smaller than Lb1/2.7.
The lips are thick if: (hb1+hb2)/2 is substantially greater than Lb1/2.7.

### Lip Size Ratios

FIG. 10 also shows the points and sizes useful in establishing the criteria for detecting the comparative size or proportions of the lips. These criteria are intended to establish the proportions of the lips relative each other. This consists in detecting the size of the lips by determining a ratio between the heights of each of the lips. For the upper lip, an average height dimension is preferably used. The lips may be classified into three categories: larger lower lip, balanced lips, larger upper lip. The points used for these criteria correspond to the upper and lower points of each lip, that is, for hb3, to the distance between the imaginary line passing through the corner of the mouth 122 and 123 and the upper point 125, on one side, for hb4, to the distance between the imaginary line passing through the corners of the mouth 122 and 123 and the upper point 124, on the other side, and for hb5, to the distance between the lower point of the lower lip 121 and the line passing through the corners of the mouth at points 122 and 123.

In the case of lips that are balanced or have similar sizes:
(hb3+hb4)/2 is substantially equal to hb5.
In the case where the lower lip is larger:
(hb3+hb4)/2 is substantially smaller than hb5.
In the case where the upper lip is larger:
(hb3+hb4)/2 is substantially greater than hb5.

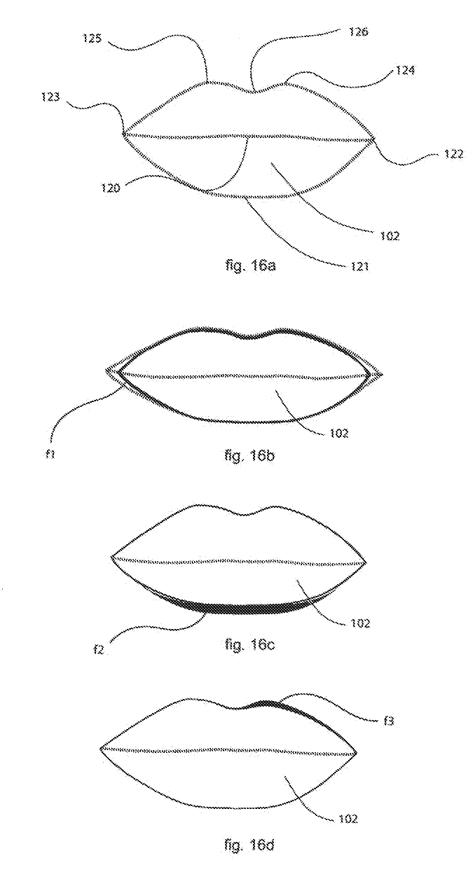

FIGS. 16a to 16d illustrate examples of corrections to be applied to lips according to the applied classifications. FIG. 16a shows balanced lips. FIGS. 16b, 16c, and 16d show examples of corrections suggested for common situations. The corrections are suggested for application along the outer outline of the lips or along one portion of the outline. It is thus possible to correct various disproportions and therefore rebalance the lips with respect to the rest of the face. Depending on the correction to be performed, the outline is redrawn along the outside or the inside of the outer boundary of the lips. Thus, in the example shown in FIG. 16b, to correct lips detected as being too wide, the outline is redrawn along line 11, with narrower borders. In FIG. 16c, a lower lip thinner than the upper lip is compensated for by means of a lower lip outline, which is redrawn along f2 in order to move the lower edge of the lower lip downwards. The example shown in FIG. 16d relates to an asymmetrical upper lip, which is corrected by an outline redrawn along f3, in order to increase the smallest detected surface area. The aim is to restore the balance between points 125 and 124 by setting them to the same level.

These examples show that rebalancing can be performed both laterally and vertically, or by a combination of these two axes.

### The Chin (FIG. 21)

FIG. 21 shows the points and sizes useful in establishing the criteria for detecting the sizes of the chin of the target image. These criteria are intended to establish the relative proportions of the chin with respect to the rest of the face and its components. The chin may thus be classified into three categories: short, normal or long. The axes of FIG. 21 are used to determine these proportions. Hv1 corresponds to the height between point 115 at the pupils and the lower point 112 of the chin. Hv2 corresponds to the height of the chin between the base of the lips 121 and the base of the chin 112.

The chin is normal or substantially equivalent to the reference image if:
3.2 units<hv2/hv1<3.8 units.
The chin is short if: hv1/hv2≦3.2 units.
The chin is long if: hv2/hv1>3.8 units.

In order to apply the corrections such that they are well suited to the type of chin detected, the method involves using different types of mask that provide corrections to the lower portion, in order to make this area more or less visible, as appropriate. In the event that the chin is too long, a makeup application which is darker than the skin tone is suggested. In the event that the chin is too short, a makeup application which is lighter than the skin tone is then recommended.

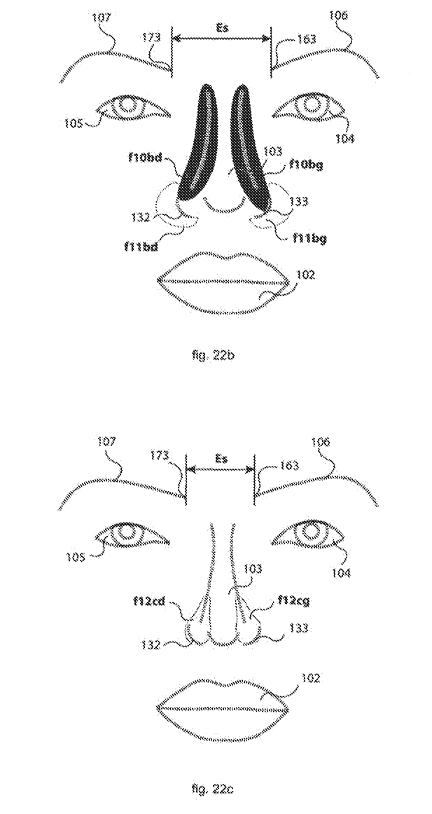

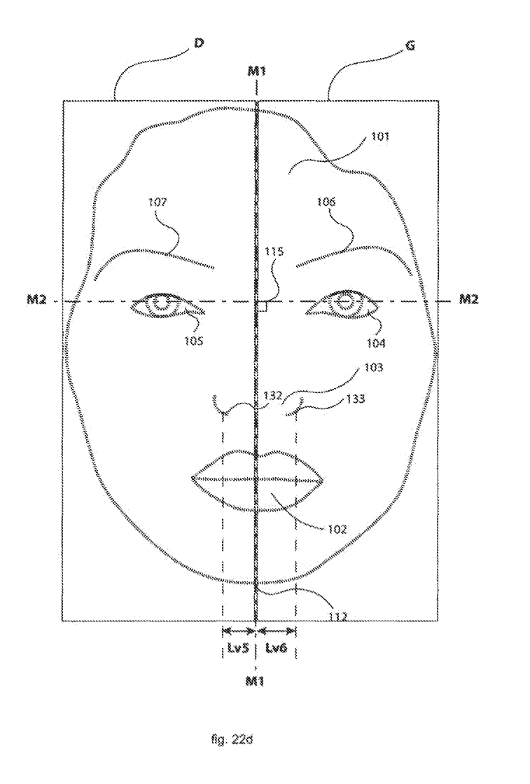

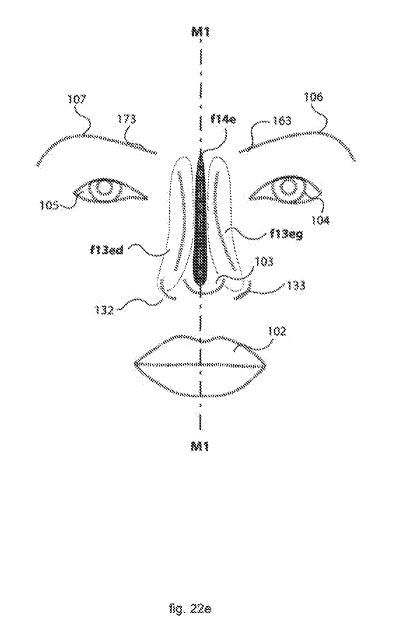

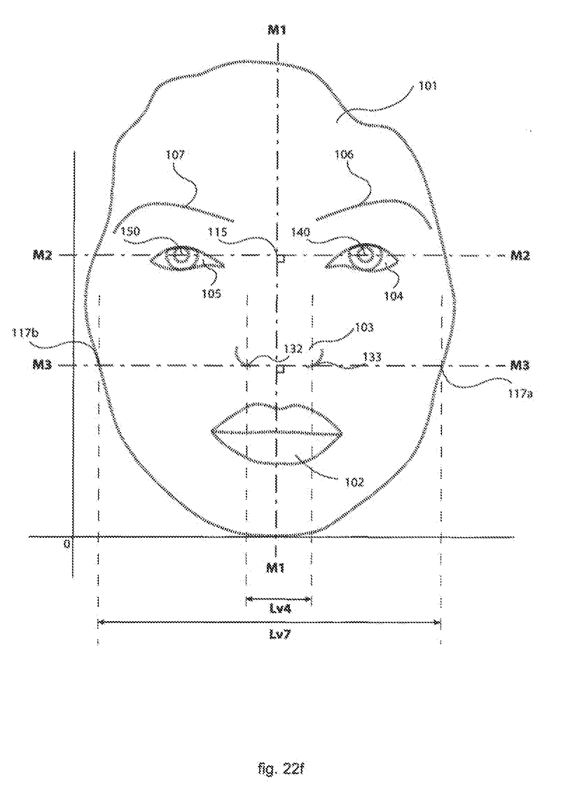

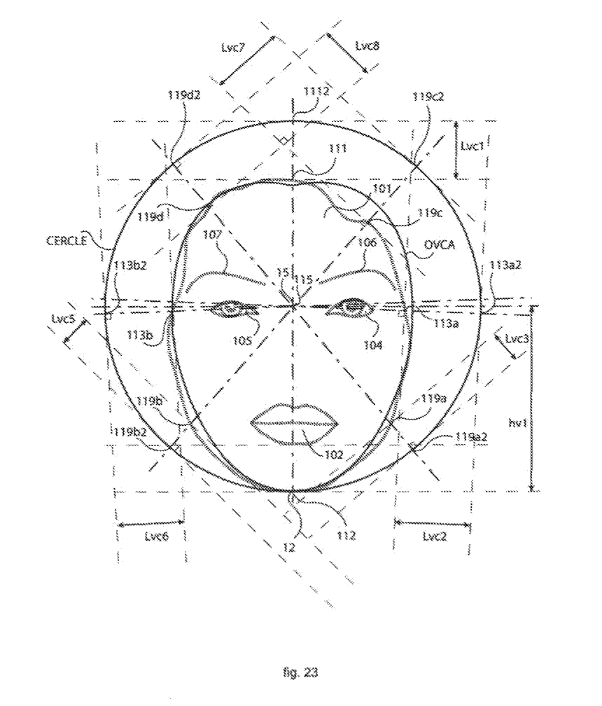

### Nose: Length of the Nose (FIG. 22)

FIG. 22 shows the points and sizes useful in establishing the criteria for detecting the size of the nose. These criteria are intended to establish the relative proportion of the nose with respect with the rest of the face. The nose can thus be classified into three categories: short, normal or long. The axes of FIG. 22a are used to determine these proportions. The height of the nose relative to the chin is preferably determined based on an average between both sides of the nose. Thus, Hv3 corresponds to the height between point 112 and the base of the chin and point 133 at the base of one side of the nose. Hv4 corresponds to the height between point 112 at the base of the chin and point 132 at the base of the other side of the nose. Hv5 corresponds to the distance between the points of the base of the nose 132, on one side, and the inner corner 153 of the eye, on the same side. Hv6 corresponds to the distance between the points of the base of the nose 133, on the other side, and the inner corner 143 of the eye, also on this side.

The nose is normal if:

0.78(hv3+hv4)/2>(hv5+hv6)/2>0.72×(hv3+hv4)/2.

The nose is short if:

(hv5+hv6)/2>0.78×(hv3+hv4)/2.

The nose is long if:

(hv5+hv6)/2<0.72×(hv3+hv4)/2.

### Width of the Nose

FIG. 22a also shows the points and sizes useful in establishing the criteria for detecting the width of the nose. These criteria are intended to determine the relative proportions of the nose with respect to the rest of the face. The nose can thus be classified into three categories: narrow, normal or wide. The axes of FIG. 22a are used to determine these proportions. The height of the nose with respect to the chin is preferably determined based on an average between both sides of the nose. Hv5 and Hv6 have already been described. Lv4 corresponds to the width between points 132 and 133 of the base of the nose, on each side of the nostrils.

The nose is normal or equivalent to the reference image if:
Lv4 is substantially equal to ⅔×(hv5+hv6)/2.
The nose is narrow if:
Lv4 is substantially smaller than ⅔×(hv5+hv6)/2.
The nose is wide if:
Lv4 is substantially greater than ⅔×(hv5+hv6)/2.

Other method for determining nose width criteria:

Similarly to FIG. 22a, FIG. 22f shows the points and sizes useful in establishing the criteria for detecting the width of the nose. The nose is also classified into three categories: narrow, normal or wide. Points 117a, 117b and 132, 133, which lie along axes M3 of FIG. 22f are used to determine these proportions. According to this approach, the category into which the nose falls can be determined by means of a comparison between the width of the face and the width of the nose. Lv4 corresponds to the width between points 132 and 133 of the base of the nose, on each side of the nostrils, and Lv4 corresponds to the width between points 117a and 117b of the face. The nose is normal or equivalent to the reference image if:

Lv4 is substantially equal to ¼×Lv7.
The nose is narrow if:
Lv4 is substantially smaller than ¼×Lv7.
The nose is wide if:
Lv4 is substantially greater than ¼×Lv7.

FIGS. 22b and 22c illustrate examples of corrections to be applied to the nose according to the classifications thus performed. FIG. 22b shows an excessively wide nose and FIG. 22c shows an excessively narrow nose. Depending on the correction to be applied, the spacing of the eyebrow, represented by distance Es, may be increased for an excessively wide nose and decreased in the opposite case. The areas F11bd and f11bg each represent an area where a texture may be applied within the recesses of the flares of the nose. The shapes f10bd and f10bg are intended for a darker makeup application than the skin tone detected, in order to darken this portion of the nose. Areas f12cd and f12cg are intended for a lighter makeup application than the skin tone detected, in order to brighten this portion of the nose.

In the case where the nose is too small, certain portions of the nose will be brightened, preferably in the upper portion, using a type of mask such as that which is illustrated. In the opposite case, if the nose is too long, a darker makeup application than the skin tone is used on the lower portion of the nose.

### The Shape of the Nose

FIG. 22d shows the points and sizes useful in establishing the criteria for detecting the shape of the nose. These criteria are intended to determine the straightness of the nose with respect to the face. The nose can thus be classified into three categories: straight, deviated to the left (area G), or deviated to the right (area D). The axes of FIG. 22d are used to determine these proportions. M1 and M2 have been previously described. Lv5 and Lv6 correspond to the width between axis M1 and points 132 and 133 of the base of the nose, on either side of the nostrils.

The nose is normal or equivalent to the reference image if:
Lv5 is substantially equal to Lv6.
The nose is deviated to the right if:
Lv5 is substantially greater than Lv6.
The nose is deviated to the left if:
Lv5 is substantially smaller than Lv6.

FIG. 22e illustrates an example of the correction to be applied to the nose according to the classifications performed for the shape of the nose. FIG. 22e shows a nose deviated to the left. In this case, to perform the compensation, it is suggested to use a mask such as that shown in the illustration. Areas F13ed and f13eg each represent an area in which the applied makeup is lighter than the skin tone detected, in order to brighten this portion of the nose. Area f14e is intended for a darker makeup application than the skin tone detected, in order to darken this portion of the nose.

### Eyebrows

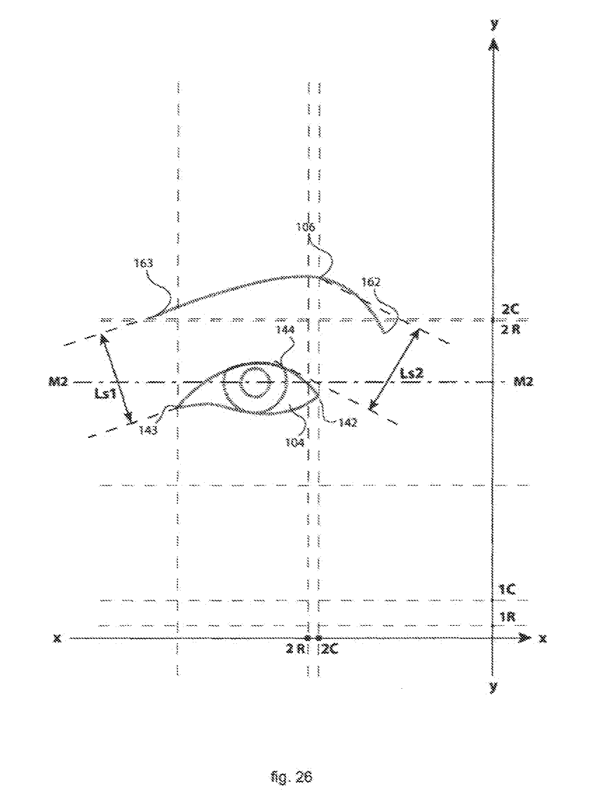

FIG. 26 shows the points useful in determining the spacing between the eye and the eyebrow. Ls1 represents the distance between the upper corner of the eye 143 and the inner end of the eyebrow 163. Ls2 represents the distance between the upper portion of the eye 144 and the top of the eyebrow 162. Based on these distances, it is possible to detect the type of spacing between the eye and the eyebrow. The type of spacing can be determined based either on Ls1, or on Ls2, or on both of these distances, with a compound or cumulative criterion. Depending on the category detected, it is possible to automatically suggest one or more types of mask that can be applied. For the user, a corresponding makeup can then be applied, based on the example given by the mask. The types of spacing are as follows;

Normal if Ls1 is substantially equal to ¼ R.

Narrow if Ls1 is substantially smaller than ¼ R.

Wide if Ls1 is substantially greater than ¼ R.

Normal if Ls2 is substantially equal to ⅓ R.

Narrow if Ls2 is substantially smaller than ⅓ R.

Wide is Ls2 is substantially greater than ⅓ R.

### Color Selection

The image processing performed to take into account the shape and facial features of the target image have been described in the preceding paragraphs. In addition to the shape and features, it is also advantageous to be able to take certain colors of the target image into account.

Conventionally, a typical makeup indeed involves predetermined colors. These colors are applied in a neutral manner, regardless of the features and shape of the face of the person to whom makeup is to be applied. However, most faces are not fully suitable for the application of colors without some adaptation. Thus, to take the individual specificities of each individual face into account, an image of the person to whom the makeup must be applied is used in order to extract certain characteristics related to the features, shape and, as appropriate, colors. By comparison with a reference image, it is then possible to automatically provide a mask, which is perfectly suited to the detected traits. Corrections or alterations of certain areas of the target image can be performed in order to bring it “closer” to the reference image. Certain areas of the target image are thus identified for color detection. This allows the most appropriate colors to be determined in order to define the mask to be applied.

Furthermore, if the user must then make herself up on the basis of the mask, it is useful to adjust the color selection according to the colors and products available to her. She can then provide these indications in various forms, such as a color code, product numbers, etc., so as to enter this information into a user database which specifies the available colors. A simple way of obtaining such data is to ask the user to provide them, for example, using an input window specially designed for this purpose. This referencing is generally facilitated by the fact that the product colors in the database have a product number which corresponds to a hexadecimal value. Colors available for a given user can be entered and classified by product categories.

Advantageously, the colors of clothing can also be taken into account for the adjustment or adaptation of the mask colors. Conversely, mask colors can be used to suggest the main visible colors to help in the selection of a dress.

When the color features of the skin, eyes and hair are known, it is possible to adapt the colors of a mask in order to obtain a customized and adapted layout. For example, the color source may be based on the various product numbers provided by the user. These colors are found in a database provided for this purpose. They can be pre-classified into categories.

The colors are sampled from determined areas of the face. These color values are usually converted to hexadecimal and then HSB (Hue, Saturation, Brightness) values. The HSB diagram materializes a three-dimensional color representation in the form of two inverted cones whose common base shows, near to the edge, the saturation maximum of the color. The center of the circle is grey, with brightness increasing upwards and decreasing downwards. One or more rules can be applied to the values obtained so as to classify them into a list of colors.

According to a preferred embodiment, the color features of three areas are used to compose the coloring mask: the eyes 104 and 105, in particular the iris (preferably without reference to the reference image for color), the skin, in particular the cheeks, as well as the hair.

For the hair and skin, a dual comparison is advantageously used, namely, on the one hand, a comparison between the position of the reference points, and on the other hand, a comparison between the colors of the areas close to the reference points. The following table lists certain typical colors for each of the areas. Depending on the classification established based on color detection, an appropriate mask can be selected. If a mask has already been selected according to the shape and feature criteria of the target image, it can be adapted or shaded in accordance with the color classification performed at this stage of the process.

TABLE 1
Classification of colors and range of values

| | | |
|---|---|---|
| Skin | Eyes | Hair |

| Color | Ref. | Color | Ref. | Color | Ref. |
|---|---|---|---|---|---|
| Pale beige | P1 | Black | Y1 | Blond | C1 |
| | | Brown | | | |
| Pale Pink | P1′ | Chestnut | Y2 | Auburn | C2 |
| Normal | P2 | Green | Y3 | Chestnut | C3 |
| Pink | | | | | |
| Normal | P2′ | Blue | Y4 | Brown- | C4 |
| beige | | | | Black | |
| Metis | P3 | Grey | Y5 | Whitish | C5 |
| | | | | Grey | |
| Black | P4 | | | | |

The search for a color that matches a target image is advantageously performed in accordance with its position in the HSB color space. This search consists in detecting the closest available colors in the database while adding any appropriate adaptation rules. The color is determined on the basis of the shortest distance between the detected colors and the colors available in the HSB space or any other equivalent space. The HSB values of a color reference are previously loaded into the database. It is also possible to apply other constraints to the selection of colors. This includes a selection per product, per manufacturer, per price, etc.

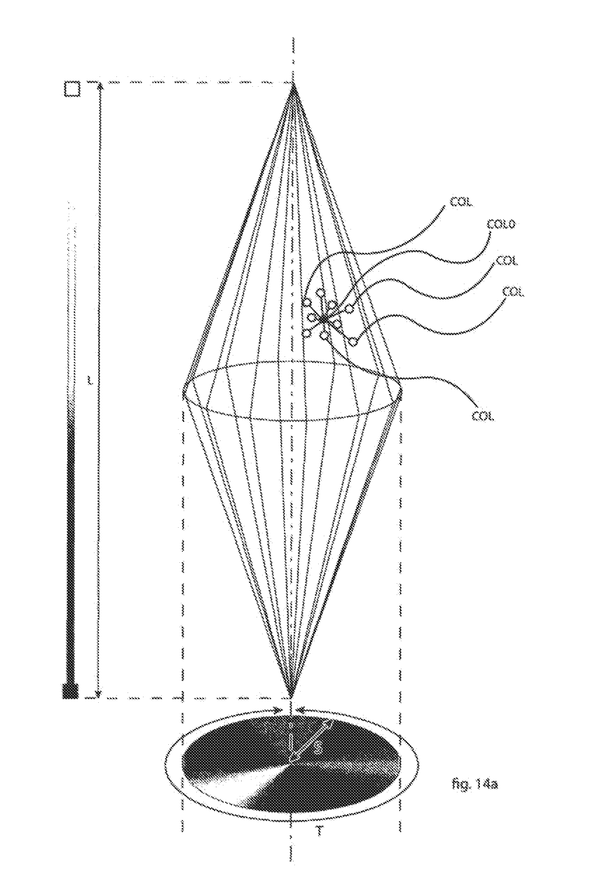

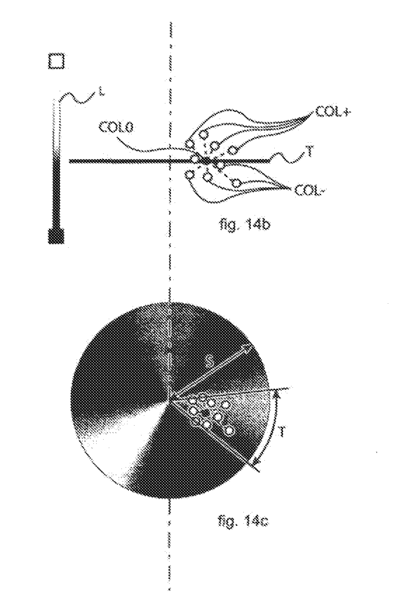

The adaptation of a mask to simulate the addition of a skin color (makeup foundation) is determined based on the skin color detected. On the HSB diagram in FIG. 14, COL0 is the position of the detected color. CO represent colors in the database. The product whose tone is the most appropriate with respect to the color of the skin can be obtained. It is also possible to introduce rules to adapt a desired tone to a harmony of colors. For example, in the case where it is desired to obtain a darker tone, it is sufficient to search for the closest color so that the brightness becomes less than that of the original color. For example, the closest distance is computed for a product having the same hue whose brightness is greater than 60% and whose saturation ranges from 40% to 60%, in order to obtain an adaptation for pale skin.

The figures and their above descriptions provide a non-limiting illustration of the invention. In particular, the present invention and its different variants have been described above in relation to a particular example which involves a canon whose characteristics correspond to those generally accepted by the skilled person. However, it will be obvious to one skilled in the art that the invention can be extended to other embodiments in which the reference image used has different characteristics for one or more points of the face. Furthermore, a reference image based on the golden number (1.618034 . . . ) could also be used.

The reference symbols used in the claims have no limiting character. The verbs “comprise” and “include” do not exclude the presence of elements other than those listed in the claims. The word “a” or “an” preceding an element does not exclude the presence of a plurality of such elements.

| | |
|---|---|
| REFERENCE | TARGET |

| | | |
|---|---|---|
| AXES | ABSCISSA AXIS | x |
| | ORDINATE AXIS | y |
| | ORIGIN | 0 |
| SIDE (with respect | LEFT SIDE | G |
| to vertical | RIGHT SIDE | D |
| symmetry line | | |
| through the center | | |
| of the face) | | |

| REFERENCE SHAPE OF FACE OUTLINE | OVCA | | | |
|---|---|---|---|---|
| UNIT | R | | D | |
| | LEFT | RIGHT | LEFT | RIGHT |
| | (G) | (D) | (G) | (D) |

POINTS ON FACE OUTLINE AND THEIR COMPONENTS

| FACE | | 1 | | 101 | |
|---|---|---|---|---|---|
| | UPPERMOST POINT OF FACE | 11 | | 111 | |
| | OUTLINE | | | | |
| | LOWERMOST POINT ON FACE | 12 | | 112 | |
| | OUTLINE | | | | |
| | POINT ON FACE OUTLINE AT | 13a | 13b | 113a | 113b |
| | THE SAME LEVEL AS INNER | | | | |
| | CORNER OF THE EYE | | | | |
| | POINT ON FACE OUTLINE AT | 14a | 14b | 114a | 114b |
| | THE SAME LEVEL AS OUTER | | | | |
| | CORNER OF THE MOUTH | | | | |
| | | 6 | 7 | 106 | 107 |
| EYEBROWS | OUTER END OF EYEBROW | 61 | 71 | 161 | 171 |
| | TOP OF EYEBROW | 62 | 72 | 162 | 172 |
| | INNER END OF EYEBROW | 63 | 73 | 163 | 173 |
| EYE | | 4 | 5 | 104 | 105 |
| | CENTER OF PUPIL | 40 | 50 | 140 | 150 |
| | LOWERMOST POINT OF IRIS | 41 | 51 | 141 | 151 |
| | OUTER CORNER OF THE EYE | 42 | 52 | 142 | 152 |
| | INNER CORNER OF THE EYE | 43 | 53 | 143 | 153 |
| | UPPER CORNER OF IRIS ON | 44 | 54 | 144 | 154 |
| | OUTER SIDE OF THE EYE | | | | |
| | UPPER CORNER OF IRIS ON | 45 | 55 | 145 | 155 |
| | INNER SIDE OF THE EYE | | | | |
| MOUTH | | 2 | | 102 | |
| | CENTER POINT BETWEEN | 20 | | 120 | |
| | OUTER CORNERS OF THE | | | | |
| | MOUTH | | | | |
| | LOWERMOST POINT OF THE | 21 | | 121 | |
| | MOUTH | | | | |
| | OUTER CORNER OF THE | 22 | 23 | 122 | 123 |
| | MOUTH (COMMISSURE) | | | | |
| | UPPERMOST POINTS OF THE | 24 | 25 | 124 | 125 |
| | MOUTH | | | | |

| | | |
|---|---|---|
| LOWERMOST POINT | 26 | 126 |
| BETWEEN HIGHEST POINTS | | |
| OF THE MOUTH (18-26) or (70-75) | | |

POINTS DERIVED FROM DETECTED OUTLINES

| NOSE | | 3 | | 103 | |
|---|---|---|---|---|---|
| | OUTER CORNER OF NOSTRILS | 31 | 32 | 131 | 132 |
| | (BASE OF NOSE) | | | | |
| FACE | POINT OF OUTLINE AT THE | 17a | 17b | 117a | 117b |
| | SAME LEVEL AS OUTER | | | | |
| | CORNER OF NOSTRILS | | | | |
| | POINT OF OUTLINE AT THE | 18a | 18b | 118a | 118b |
| | SAME LEVEL AS LOWERMOST | | | | |
| | POINT OF THE MOUTH | | | | |

| | | |
|---|---|---|
| MIDDLE OF DISTANCE | 15 | 115 |
| BETWEEN PUPIL CENTERS | | |
| MIDDLE OF DISTANCE | 16 | 116 |
| BETWEEN INNER CORNERS | | |
| OF THE EYE | | |

| | | |
|---|---|---|
| AXES | AXIS THROUGH MIDDLE OF | M1 |
| | PUPILS | |
| | AXIS THROUGH CENTER | M2 |
| | POINTS OF PUPILS | |
| | AXIS THROUGH CORNERS OF | M3 |
| | NOSTRILS | |

LEGEND OF COLOR DIAGRAM (FIG. 14a)

| | | |
|---|---|---|
| COLORS | COLORIMETRY VALUES OF | COL+ |
| | BRIGHTER DATABASE | |
| | COLORIMETRY VALUES OF | COL− |
| | DARKER DATABASE | |
| | SOURCE COLORIMETRY | COL0 |
| | VALUE | |
| | SOURCE | |
| UNITS OF HSB | HUE (unit: °) | H |
| SPACE | SATURATION (unit: %) | S |
| | BRIGHTNESS (unit: %) | B |

CUSTOMIZATION OF MASKS

| MOUTH | SHAPE TO CORRECT MOUTH | f1 | |
|---|---|---|---|
| | WIDTH | | |
| | SHAPE TO CORRECT | f2 | |
| | DISPROPORTION OF LOWER | | |
| | LIP HEIGHT RELATIVE TO | | |
| | UPPER LIP | | |
| | SHAPE TO CORRECT | f3 | |
| | SYMMETRY OF UPPER LIP | | |
| EYELID | MEDIUM TONE AREA | f4a, f4b, f4c | |
| | DARK TONE AREA | f5a, f5b, f5c | |
| | LIGHT TONE AREA | f6a, f6b, f6c | |
| FACE | FACE SIDE AREA | f7ad, | f7ag, |
| | | f7bd, | f7bg, |
| | | f7cd | f7cg |

| | | |
|---|---|---|
| | FOREHEAD AREA | f8b, f8c |
| | CHIN AREA | f9b, f9c |
| NOSE | SIDE FLARE AREA | f10bg, f10bd, |
| | | f13eg, f13ed |
| | NOSE FLARE AREA | f12cg, f12cd |
| | AREA AROUND NOSE FLARES | f11bg, f11bd |
| | CENTRAL AREA | f14e |
| EYEBROW | DISTANCE BETWEEN | Es |
| | EYEBROWS | |

1. An automatic image-processing method for the application of a mask to be applied to a target image, comprising:
a) obtaining a digital target image, comprising an image representing a face;
b) for at least one area of the target image, via a comparison module, identifying the reference points corresponding at least to points defining a spatial imperfection;
c) for at least the area of the target image, via the comparison module, applying at least one spatial imperfection detection test by comparing the target image with a reference image;
d) depending on the detected spatial imperfection, via a selection module identifying a spatial correction mask to be applied to the area of the target image including the detected spatial imperfection;
e) via an application module, applying the spatial correction mask to the area of the target image.

2. The automatic image-processing method of claim 1, further comprising, before the step of applying the spatial correction mask:
identifying at least one color feature of the area of the target image;
generating color correction features for the color feature;
adding the color correction features to the spatial correction mask to generate an overall correction mask; and
applying the overall correction mask to the area of the target image.

3. The automatic image-processing method according to claim 1, wherein the comparison between the target image and the reference image includes comparing at least one key point of the area of the target image and at least one corresponding point of the reference image.

4. The automatic image-processing method according to claim 1, wherein the target image is substantially from the front of the face, and the area of the target image is selected from a group consisting of mouth, eyes, eyebrows, face outline, nose, and cheeks.

5. The automatic image-processing method according to claim 4, wherein the area of the target image comprises the mouth and the reference points comprise at least corners of the mouth.

6. The automatic image-processing method according to claim 4, wherein the area of the target image comprises the eyes.

7. The automatic image-processing method according to claim 4, wherein the area of the target image comprises the eyebrows.

8. The automatic image-processing method according to claim 1, wherein the reference points further comprise a plurality of points located substantially along the an outline of the face.

9. An automatic image-processing system for application of a mask to a target image, comprising:
a comparison module adapted to perform a comparison between predetermined features of at least one area of a target image and corresponding features of a reference image based on test criteria that detect imperfections in the area of the target image with respect to the shape features of the area of the target image;
a selection module adapted to select at least one correction mask to be applied to the area of the target image, the correction mask being selected according to the type of imperfection detected by the comparison module; and
an application module adapted to apply the correction mask to the area of the target image to generate a modified image.

10. The image-processing system of claim 9, wherein the comparison, selection and application modules are integrated into a work module implemented by coded instructions, the work module being adapted to obtain target image data, reference image data and test criteria.

11. The image-processing system according to claim 10, wherein the target image is substantially from the front of the face, and the area of the target image is selected from a group consisting of mouth, eyes, eyebrows, face outline, nose, and cheeks.

12. The image-processing system according to claim 11, wherein the area of the target image comprises the mouth.

13. The image-processing system according to claim 12, wherein the comparison module also identifies reference points and the reference points comprise at least corners of the mouth.

14. The image-processing system according to claim 11, wherein the area of the target image comprises the eyes.

15. The image-processing system according to claim 11, wherein the area of the target image comprises the eyebrows.

16. The automatic image-processing method according to claim 11, wherein the reference points comprise a plurality of points located substantially along an outline of the face.
